(19) United States
(12) Patent Application Publication
(10) Pub. No.: US 2024/0406829 A1
(43) Pub. Date: Dec. 5, 2024

(54) WIRELESS COMMUNICATION DEVICE, WIRELESS COMMUNICATION METHOD, AND RECORDING MEDIUM

(71) Applicant: NEC CORPORATION, Minato-ku, Tokyo (JP)

(72) Inventor: Kiyoshi BABA, Tokyo (JP)

(73) Assignee: NEC CORPORATION, Minato-ku, Tokyo (JP)

(21) Appl. No.: 18/700,766

(22) PCT Filed: Oct. 27, 2022
(86) PCT No.: PCT/JP2022/040100

§ 371 Date: Apr. 12, 2024

(30) Foreign Application Priority Data
Nov. 18, 2021 (JP) 2021-187500

(51) Int. Cl. H04W 36/30; H04W 36/00

(52) U.S. Cl. CPC H04W 36/304; H04W 36/00837

(57) ABSTRACT

In order to enable reducing deterioration of communication efficiency and loss of data caused by the switching of a wireless link, a wireless communication method includes transmitting a wireless communication frame via a first wireless link or a second wireless link, measuring a first communication quality that is a communication quality of the first wireless link and a second communication quality that is a communication quality of the second wireless link, changing a size of the wireless communication frame based on the first communication quality and the second communication quality, generating the wireless communication frame having the changed size, and switching a wireless link used for transmission of the wireless communication frame from the first wireless link to the second wireless link based on the first communication quality and the second communication quality.

### TECHNICAL FIELD

The present invention relates to a wireless communication device and the like.

### BACKGROUND ART

As the mobile wireless communication device moves, the mobile wireless communication device switches a wireless link to be used for wireless communication. Examples of a method for switching the wireless link include methods described in PTL 1 and PTL 2. The switching of the wireless link is also referred to as handover.

In the method described in PTL 1, in a case where the handover is performed during the transmission of the wireless frame, the start of the handover is delayed until the transmission of the wireless frame ends. In addition, in the method described in PTL 2, at the time of handover, control is performed such that data considered to be lost due to the handover is accumulated in a buffer and transmitted after completion of the handover. In these methods, data loss at the time of handover can be reduced.

### CITATION LIST

### Patent Literature

PTL 1: JP 2000-092542 A
PTL 2: WO 2009/119765 A1

### SUMMARY OF INVENTION

### Technical Problem

However, in the methods described in PTL 1 and PTL 2, the handover cannot be started until the transmission of the wireless frame is completed. Therefore, in a case where a wireless frame having a large size is transmitted immediately before the handover, the time until the handover is started becomes long. As a result, the communication quality deteriorates before the handover is started, and there is a possibility that the communication efficiency may deteriorate or data loss may occur.

In view of the above-described problems, an object of the present invention is to provide a wireless communication device and the like that can reduce deterioration of communication efficiency and loss of data caused by the switching of a wireless link.

### Solution to Problem

In one aspect of the present invention, a wireless communication device includes a generation means that generates a wireless communication frame, a transmission means that transmits the wireless communication frame via a first wireless link or a second wireless link, and a measurement means that measures a first communication quality that is a communication quality of the first wireless link and a second communication quality that is a communication quality of the second wireless link, wherein the first wireless link is a wireless link used for transmission of the wireless communication frame and the second wireless link is a wireless link having a possibility of being used for transmission of the wireless communication frame, the generation means changes a size of the wireless communication frame based on the first communication quality and the second communication quality, and generates the wireless communication frame having the changed size, and the transmission means switches a wireless link used for transmission of the wireless communication frame from the first wireless link to the second wireless link between completion of the transmission of the wireless communication frame and start of transmission of the next wireless communication frame based on the first communication quality and the second communication quality.

Furthermore, in another aspect of the present invention, a wireless communication method includes transmitting a wireless communication frame via a first wireless link or a second wireless link, measuring a first communication quality that is a communication quality of the first wireless link and a second communication quality that is a communication quality of the second wireless link, the first wireless link being a wireless link used for transmission of the wireless communication frame and the second wireless link being a wireless link having a possibility of being used for transmission of the wireless communication frame, changing a size of the wireless communication frame based on the first communication quality and the second communication quality, and generating the wireless communication frame having the changed size, and switching a wireless link used for transmission of the wireless communication frame from the first wireless link to the second wireless link between completion of the transmission of the wireless communication frame and start of transmission of the next wireless communication frame based on the first communication quality and the second communication quality.

Moreover, in another aspect of the present invention, a computer-readable recording medium recorded with a wireless communication program causes a computer to achieve a generation function for generating a wireless communication frame, a transmission function for transmitting the wireless communication frame via a first wireless link or a second wireless link, and a measurement function for measuring a first communication quality that is a communication quality of the first wireless link and a second communication quality that is a communication quality of the second wireless link, wherein the first wireless link is a wireless link used for transmission of the wireless communication frame and the second wireless link is a wireless link having a possibility of being used for transmission of the wireless communication frame, the generation function changes a size of the wireless communication frame based on the first communication quality and the second communication quality, and generates the wireless communication frame having the changed size, and the transmission function switches a wireless link used for transmission of the wireless communication frame from the first wireless link to the second wireless link between completion of the transmission of the wireless communication frame and start of transmission of the next wireless communication frame based on the first communication quality and the second communication quality.

### Advantageous Effects of Invention

According to the present invention, deterioration of communication efficiency and loss of data caused by switching of a wireless link can be reduced.

### BRIEF DESCRIPTION OF DRAWINGS

FIG. 1 is a diagram illustrating a configuration example of a wireless communication device according to a first example embodiment of the present invention.

FIG. 2 is a diagram illustrating an example of an operation flow of the wireless communication device of the first example embodiment of the present invention.

FIG. 3 is a diagram illustrating an example of an operation flow of the wireless communication device of the first example embodiment of the present invention.

FIG. 4 is a diagram illustrating a configuration example of a system including a wireless communication device according to a second example embodiment of the present invention.

FIG. 5 is a diagram illustrating a configuration example of a wireless communication device according to the second example embodiment of the present invention.

FIG. 6 is a diagram illustrating an example of a wireless communication frame regarding the wireless communication device of the second example embodiment of the present invention.

FIG. 7 is a diagram illustrating an example of a history of communication quality regarding the wireless communication device of the second example embodiment of the present invention.

FIG. 8 is a diagram illustrating a hardware configuration example of each example embodiment of the present invention.

### EXAMPLE EMBODIMENT

### First Example Embodiment

A first example embodiment of the present invention is described. A specific example of a wireless communication device 10 in the first example embodiment is a wireless communication device 20 in a second example embodiment described later.

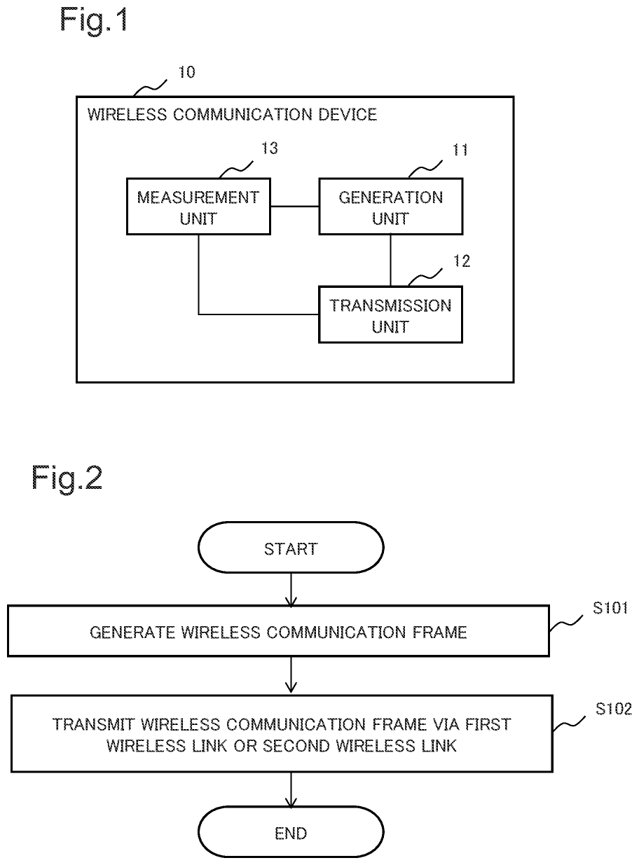

FIG. 1 illustrates a configuration example of the wireless communication device 10 of the present example embodiment. The wireless communication device 10 of the present example embodiment includes a generation unit 11, a transmission unit 12, and a measurement unit 13.

The generation unit 11 generates a wireless communication frame. The transmission unit 12 transmits a wireless communication frame via a first wireless link or a second wireless link. The measurement unit 13 measures a first communication quality that is the communication quality of the first wireless link and a second communication quality that is the communication quality of the second wireless link.

The first wireless link is a wireless link used for transmission of a wireless communication frame. The second wireless link is a wireless link having the possibility of being used for transmission of a wireless communication frame.

In addition, the generation unit 11 changes the size of the wireless communication frame based on the first communication quality and the second communication quality, and generates the wireless communication frame having the changed size.

In addition, the transmission unit 12 switches the wireless link to be used for the transmission of the wireless communication frame from the first wireless link to the second wireless link based on the first communication quality and the second communication quality. That is, the transmission unit 12 switches the wireless link to be used for the transmission of the wireless communication frame from the first wireless link to the second wireless link. After the switching, the transmission unit 12 transmits the wireless communication frame using the second wireless link. The transmission unit 12 switches the wireless link to be used for transmission of the wireless communication frame between the completion of transmission of the wireless communication frame and the start of transmission of the next wireless communication frame.

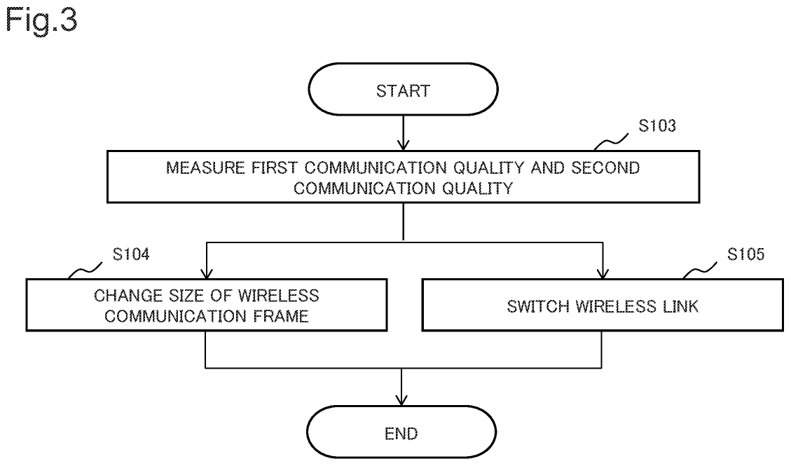

Next, FIGS. 2 and 3 illustrate an example of an operation flow of the wireless communication device 10 according to the present example embodiment.

FIG. 2 is an operation flow related to the transmission of a wireless communication frame in the operation flow of the wireless communication device 10.

The generation unit 11 generates a wireless communication frame (step S101). The transmission unit 12 transmits a wireless communication frame via the first wireless link or the second wireless link (step S102).

FIG. 3 is an operation flow related to the change of the size of the wireless communication frame and the switching of the wireless link in the operation flow of the wireless communication device 10.

The measurement unit 13 measures a first communication quality that is the communication quality of the first wireless link and a second communication quality that is the communication quality of the second wireless link (step S103).

In addition, the generation unit 11 changes the size of the wireless communication frame based on the first communication quality and the second communication quality (step S104). In step S101, the generation unit 11 generates a wireless communication frame having a changed size. In addition, the transmission unit 12 switches the wireless link to be used for the transmission of the wireless communication frame from the first wireless link to the second wireless link based on the first communication quality and the second communication quality (step S105).

As described above, in the first example embodiment of the present invention, the wireless communication device 10 includes the generation unit 11, the transmission unit 12, and the measurement unit 13. The generation unit 11 generates a wireless communication frame. The transmission unit 12 transmits a wireless communication frame via a first wireless link or a second wireless link. The measurement unit 13 measures a first communication quality that is the communication quality of the first wireless link and a second communication quality that is the communication quality of the second wireless link. The first wireless link is a wireless link used for transmission of a wireless communication frame. The second wireless link is a wireless link having the possibility of being used for transmission of a wireless communication frame. In addition, the generation unit 11 changes the size of the wireless communication frame based on the first communication quality and the second communication quality, and generates the wireless communication frame having the changed size. In addition, the transmission unit 12 switches the wireless link to be used for the transmission of the wireless communication frame from the first wireless link to the second wireless link based on the first communication quality and the second communication quality. The transmission unit 12 switches the wireless link to be used for transmission of the wireless communication frame between the completion of transmission of the wireless communication frame and the start of transmission of the next wireless communication frame.

In this way, the size of the wireless communication frame can be increased in the case of the communication quality in which the possibility of switching the wireless link is low, and the size of the wireless communication frame can be reduced in the case of the communication quality in which the possibility of switching the wireless link is high. When the size of the wireless communication frame is increased, a large amount of data can be transmitted at one time, in such a way that communication efficiency can be improved. In addition, when the size of the wireless communication frame is reduced, the time until the transmission of the wireless communication frame is completed can be shortened. As a result, the possibility that the communication quality deteriorates before the wireless link is switched can be reduced. Therefore, it is possible to reduce deterioration of communication efficiency and loss of data caused by the switching of the wireless link.

### Second Example Embodiment

Next, a wireless communication device 20 according to a second example embodiment of the present invention is described.

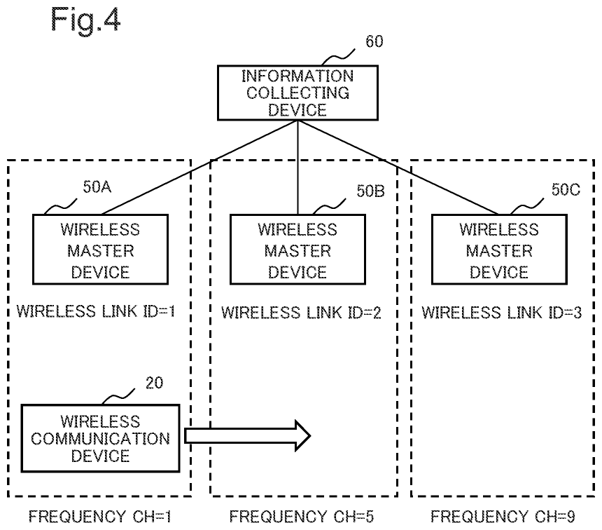

First, FIG. 4 illustrates a configuration example of a system using the wireless communication device 20 of the present example embodiment. Information collecting device 60 and wireless master device 50A to wireless master device 50C are connected to each other. The wireless communication device 20 is connected to any one of the wireless master device 50A to the wireless master device 50C by wireless communication. The number of wireless master devices in the system is arbitrary and is equal to or more than two.

The wireless communication device 20 is, for example, a mobile wireless communication device mounted on a robot or the like. The wireless communication device 20 transmits data to the information collecting device 60 via any one of the wireless master device 50A to the wireless master device 50C. The wireless communication device 20 continues data transmission to the information collecting device 60 by changing the wireless master device of the connecting destination with the movement.

The wireless master device 50A to the wireless master device 50C transmits data received from the wireless communication device 20 to the information collecting device 60. The information collecting device 60 receives the data transmitted by the wireless communication device 20 via any one of the wireless master device 50A to the wireless master device 50C.

The wireless communication line provided by the wireless master device 50A to the wireless master device 50C is referred to as a wireless link. Furthermore, the wireless master device whose coverage areas of the wireless links are adjacent to each other use frequency channels (CH) different from each other for wireless communication. In the example illustrated in FIG. 4, the frequency CH used by the wireless master device 50A is 1, the frequency CH used by the wireless master device 50B is 5, and the frequency CH used by the wireless master device 50C is 9.

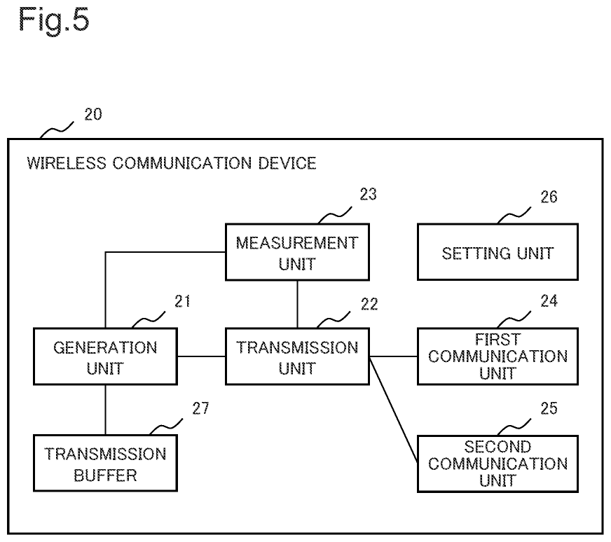

Next, FIG. 5 illustrates a configuration example of the wireless communication device 20 of the present example embodiment. The wireless communication device 20 of the present example embodiment includes a generation unit 21, a transmission unit 22, a measurement unit 23, a first communication unit 24, a second communication unit 25, a setting unit 26, and a transmission buffer 27.

The transmission buffer 27 stores a data frame scheduled to be transmitted.

The generation unit 21 generates a wireless communication frame. More specifically, the generation unit 21 extracts the data frame stored in the transmission buffer 27 from the transmission buffer, and stores the data frame in the wireless communication frame, thereby generating the wireless communication frame.

The generation unit 21 may encode the data frame and then store the encoded data frame in the wireless communication frame. The generation unit 21 encodes the data frame in order to improve wireless communication efficiency.

Examples of the encoding system include a non-retransmission redundancy encoding system. In the non-retransmission redundancy encoding system, the transmitting side encodes one or a plurality of data frames of equal to or more than two to generate one wireless communication frame. Furthermore, the transmitting side transmits the wireless communication frame until receiving an acknowledgement (ACK) from the receiving side. When receiving a predetermined number of wireless communication frames, the receiving side can decode the original data frame. When the decoding of the wireless communication frame is completed, the receiving side transmits the ACK to request transmission of the next wireless communication frame. Therefore, in the non-retransmission redundancy encoding system, when the wireless link used by the wireless communication device 20 is switched before the decoding of the wireless communication frame is completed, deterioration of the wireless communication efficiency and loss of data occur.

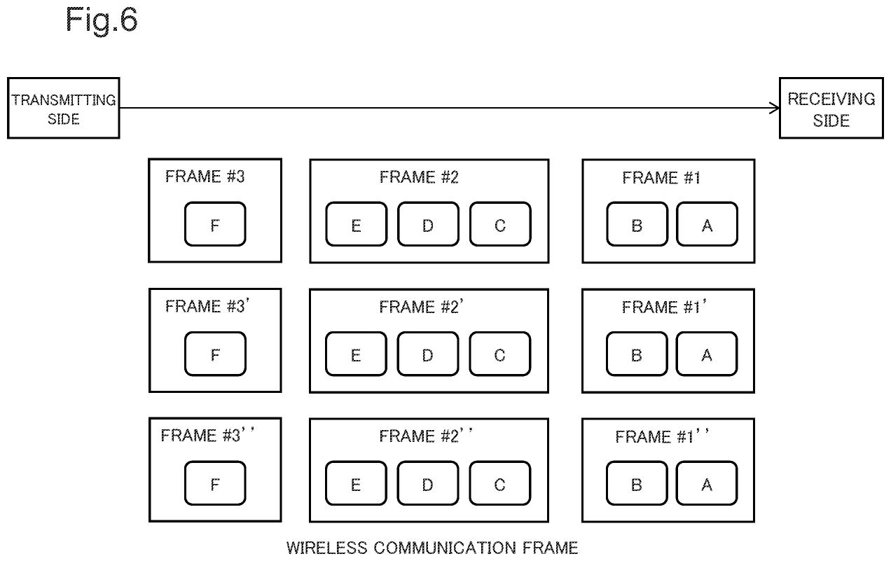

FIG. 6 illustrates an example of a wireless communication frame by the non-retransmission redundancy encoding system. A to F are data frames. Frames #1 to #3 are wireless communication frames. In the example illustrated in FIG. 6, the transmitting side repeats the transmission of the frames #1 to #3 until the ACK is transmitted from the receiving side.

In addition, the generation unit 21 changes the size of the wireless communication frame based on the first communication quality and the second communication quality. The first communication quality and the second communication quality is described later. Furthermore, a specific method of changing the size of the wireless communication frame will also be described later.

The transmission unit 22 transmits a wireless communication frame via a first wireless link or a second wireless link. Specifically, the transmission unit 22 transmits the wireless communication frame to the first communication unit 24 or the second communication unit 25. Furthermore, when receiving the ACK from the receiving side, the transmission unit 22 deletes the transmission completed data frame from the transmission buffer 27.

The first communication unit 24 performs wireless communication using the first wireless link. Note that in the present example embodiment, the first wireless link is a wireless link used by the transmission unit 22 to transmit a wireless communication frame.

The second communication unit 25 performs wireless communication using the second wireless link. In the present example embodiment, the second wireless link is an alternative candidate wireless link.

In the present example embodiment, a case where the wireless communication device 20 has two communication units is described. However, the number of communication units included in the wireless communication device 20 may be one or may be equal to or more than three. In a case where the wireless communication device 20 includes one communication unit, the communication unit enables the measurement unit 23 to measure the communication quality of the second wireless link while performing communication using the first wireless link.

The measurement unit 23 measures the first communication quality and the second communication quality. The first communication quality is the communication quality of the first wireless link. The second communication quality is the communication quality of the second wireless link. The measurement unit 23 monitors the wireless communication of the first communication unit 24 and measures the first communication quality. In addition, the measurement unit 23 measures the communication quality of the second wireless link using the second communication unit 25.

The communication quality is, for example, reception field intensity (signal strength), communication delay, or the like. The communication delay may be, for example, a time from the start of transmission of the wireless communication frame to the reception of the ACK.

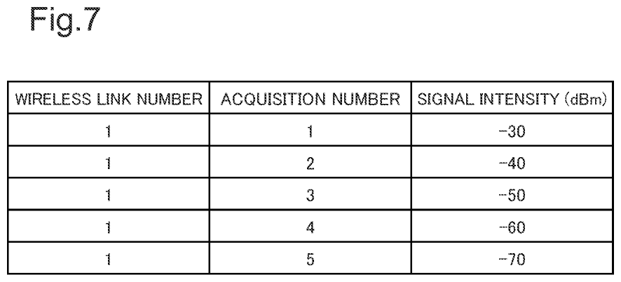

The measurement unit 23 stores the measured communication quality in a storage unit (not illustrated) as a management table. FIG. 7 illustrates an example of a management table of the communication quality. The wireless link number is identification information (identification (ID)) of a wireless link. The acquisition number indicates a measurement order of the communication quality. Furthermore, in the example of FIG. 6, the signal strength is recorded as the communication quality. In the case of the example of FIG. 6, the signal intensity decreases with elapse of time. Therefore, in the case of the example of FIG. 6, it can be estimated that the wireless communication device 20 is moving in a direction of moving away from the wireless master device of the wireless link having the identification information of “1”.

In addition, the transmission unit 22 switches the wireless link to be used for transmission of the wireless communication frame from the used first wireless link to the alternative candidate second wireless link based on the first communication quality and the second communication quality.

Specifically, the transmission unit 22 switches the communication unit to be used for transmission of the wireless communication frame from the first communication unit 24 to the second communication unit 25. In this case, after the switching, the second communication unit 25 before the switching becomes a new first communication unit 24. Then, the new first communication unit 24 transmits the wireless communication frame using the second wireless link before the switching as the new first wireless link. In addition, the first communication unit 24 before switching becomes a new second communication unit 25. Then, the new second communication unit 25 uses the new alternative candidate second wireless link.

Alternatively, the setting unit 26 to be described later may change the wireless link used for the wireless communication by the first communication unit 24 from the first wireless link to the second wireless link. In this case, after the switching, the first communication unit 24 transmits the wireless communication frame using the second wireless link before the switching as the new first wireless link, and the second communication unit 25 uses the new alternative candidate second wireless link.

The transmission unit 22 switches the wireless link to be used for transmission of the wireless communication frame between the completion of transmission of the wireless communication frame and the start of transmission of the next wireless communication frame.

The setting unit 26 performs setting necessary for wireless communication with respect to the first communication unit 24 and the second communication unit 25. The setting necessary for the wireless communication is, for example, setting of a service set identifier (SSID). The setting unit 26 acquires the setting information by, for example, reading the setting information stored in the external memory, dynamically acquiring the setting information via wired communication, or the like, and performs setting.

Next, a method of changing the size of the wireless communication frame is described.

For example, the generation unit 21 changes the size of the wireless communication frame by changing the number of data frames stored in one wireless communication frame.

In addition, the generation unit 21 reduces the size of the wireless communication frame in a case where the possibility that the transmission unit 22 switches the wireless link to be used for transmission of the wireless communication frame is high. In addition, in a case where the possibility of switching is low, the generation unit 21 increases the size of the wireless communication frame.

More specifically, the generation unit 21 increases the size of the wireless communication frame in a case where the first communication quality is better than a predetermined threshold and there is no deterioration tendency. The generation unit 21 can estimate the presence or absence of the deterioration tendency based on the history of the communication quality (e.g., FIG. 7). When the first communication quality is better than the predetermined threshold and there is no deterioration tendency, switching of the wireless link is unnecessary for a while. Therefore, the efficiency of the wireless communication can be improved by storing as many data frames stored in the transmission buffer 27 as possible in the wireless communication frames and transmitting the frames.

Furthermore, in a case where the first communication quality has deterioration tendency and the second communication quality has improvement tendency, the generation unit 21 reduces the size of the wireless communication frame. In such a case, there is a high possibility that switching to the second wireless link is performed at some time. Therefore, the size of the wireless communication frame is reduced by giving priority to switching the wireless link at an appropriate timing. In this way, it is possible to avoid the communication quality from deteriorating because the switching to the second wireless link cannot be performed until the transmission of the wireless communication frame is completed.

When the difference between the first communication quality and the second communication quality is smaller than a predetermined range, the generation unit 21 reduces the size of the wireless communication frame. In such a case, it is assumed that the wireless communication device 20 exists near the boundary between the range of the first wireless link and the range of the second wireless link. Therefore, the size of the wireless communication frame is reduced by giving priority to switching the wireless link at an appropriate timing. In this way, it is possible to avoid the communication quality from deteriorating because the switching to the second wireless link cannot be performed until the transmission of the wireless communication frame is completed.

Next, an example of an operation flow of the wireless communication device 20 of the present example embodiment is described with reference to FIGS. 2 and 3.

The generation unit 21 extracts the data frame from the transmission buffer 27 and generates a wireless communication frame (step S101). The transmission unit 22 transmits a wireless communication frame via the first wireless link or the second wireless link (step S102).

The measurement unit 23 measures a first communication quality that is the communication quality of the first wireless link and a second communication quality that is the communication quality of the second wireless link at a predetermined timing such as every predetermined time (step S103).

In addition, the generation unit 21 changes the size of the wireless communication frame based on the first communication quality and the second communication quality (step S104). After the change, in step S101, the generation unit 21 generates a wireless communication frame of the changed size.

In addition, the transmission unit 22 switches the wireless link to be used for transmission of the wireless communication frame from the used first wireless link to the second wireless link based on the first communication quality and the second communication quality (step S105).

As described above, in the second example embodiment of the present invention, the wireless communication device 20 includes the generation unit 21, the transmission unit 22, and the measurement unit 23. The generation unit 21 generates a wireless communication frame. The transmission unit 22 transmits a wireless communication frame via a first wireless link or a second wireless link. The measurement unit 23 measures a first communication quality that is the communication quality of the first wireless link and a second communication quality that is the communication quality of the second wireless link. The first wireless link is a wireless link used for transmission of a wireless communication frame. The second wireless link is a wireless link having the possibility of being used for transmission of a wireless communication frame. In addition, the generation unit 21 changes the size of the wireless communication frame based on the first communication quality and the second communication quality, and generates the wireless communication frame having the changed size. In addition, the transmission unit 22 switches the wireless link to be used for the transmission of the wireless communication frame from the first wireless link to the second wireless link based on the first communication quality and the second communication quality. The transmission unit 22 switches the wireless link to be used for transmission of the wireless communication frame between the completion of transmission of the wireless communication frame and the start of transmission of the next wireless communication frame.

In this way, the size of the wireless communication frame can be increased in the case of the communication quality in which the possibility of switching the wireless link is low, and the size of the wireless communication frame can be reduced in the case of the communication quality in which the possibility of switching the wireless link is high. When the size of the wireless communication frame is increased, a large amount of data can be transmitted at one time, in such a way that communication efficiency can be improved. In addition, when the size of the wireless communication frame is reduced, the time until the transmission of the wireless communication frame is completed can be shortened. As a result, the possibility that the communication quality deteriorates before the wireless link is switched can be reduced. Therefore, it is possible to reduce deterioration of communication efficiency and loss of data caused by the switching of the wireless link.

In addition, the wireless communication device 20 of the present example embodiment changes the size of the wireless communication frame by changing the number of data frames stored in one wireless communication frame. As a result, in the wireless communication device 20 capable of changing the number of data frames stored in one wireless communication frame, deterioration of communication efficiency and loss of data caused by switching of a wireless link can be reduced.

In addition, the wireless communication device 20 of the present example embodiment increases the size of the wireless communication frame in a case where the first communication quality is better than a predetermined threshold and there is no deterioration tendency. In this case, switching of the wireless link is unnecessary for a while. Therefore, the efficiency of the wireless communication can be improved by storing as many data frames as possible in the wireless communication frames and transmitting the data frames.

In addition, the wireless communication device 20 of the present example embodiment reduces the size of the wireless communication frame in a case where the first communication quality has deterioration tendency and the second communication quality has improvement tendency. In such a case, there is a high possibility that switching to the second wireless link is performed at some time. Therefore, by reducing the size of the wireless communication frame, it is possible to avoid the communication quality from deteriorating because the switching to the second wireless link cannot be performed until the transmission of the wireless communication frame is completed.

When the difference between the first communication quality and the second communication quality is smaller than a predetermined range, the wireless communication device 20 of the present example embodiment reduces the size of the wireless communication frame. In such a case, it is assumed that the wireless communication device 20 exists near the boundary between the range of the first wireless link and the range of the second wireless link. Therefore, by reducing the size of the wireless communication frame, it is possible to avoid the communication quality from deteriorating because the switching to the second wireless link cannot be performed until the transmission of the wireless communication frame is completed.

### Hardware Configuration Example

A configuration example of hardware resources that achieve the wireless communication device (10, 20) in each example embodiment of the present invention described above using one information processing device (computer) is described. The wireless communication device may be achieved physically or functionally by using at least two information processing devices. In addition, the wireless communication device may be achieved as a dedicated device. In addition, only some functions of the wireless communication device may be achieved by using the information processing device.

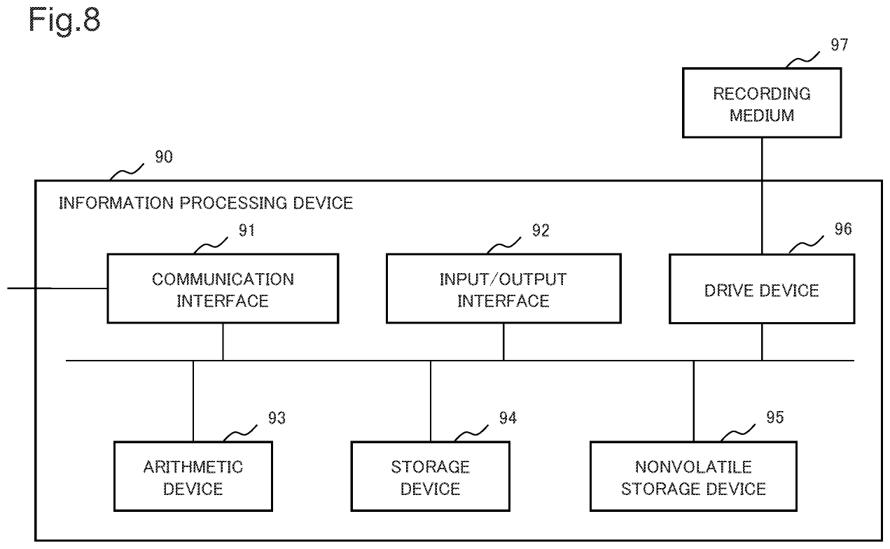

FIG. 8 is a diagram schematically illustrating a hardware configuration example of an information processing device capable of achieving the wireless communication device of each example embodiment of the present invention. The information processing device 90 includes a communication interface 91, an input/output interface 92, an arithmetic device 93, a storage device 94, a nonvolatile storage device 95, and a drive device 96.

For example, the transmission unit 12 in FIG. 1 can be achieved by the communication interface 91. In addition, the generation unit 11 and the measurement unit 13 can be achieved by the arithmetic device 93.

The communication interface 91 is a communication means for the wireless communication device of each example embodiment to communicate with an external device in a wired or/and wireless manner. Note that, in a case where the wireless communication device is achieved by using at least two information processing devices, the devices may be connected in such a way as to be able to communicate with each other via the communication interface 91.

The input/output interface 92 is a man-machine interface such as a keyboard serving as an example of an input device or a display serving as an output device.

The arithmetic device 93 is achieved by a general-purpose central processing unit (CPU), an arithmetic processing device such as a microprocessor, or a plurality of electric circuits. For example, the arithmetic device 93 can read various programs stored in the nonvolatile storage device 95 into the storage device 94 and execute processes according to the read program.

The storage device 94 is a memory device such as a random access memory (RAM) that can be referred to from the arithmetic device 93, and stores programs, various data, and the like. The storage device 94 may be a volatile memory device.

The nonvolatile storage device 95 is a nonvolatile storage device such as a read only memory (ROM) or a flash memory, and can store various programs, data, and the like.

The drive device 96 is, for example, a device that processes reading and writing of data on a recording medium 97 described later.

The recording medium 97 is an arbitrary recording medium capable of recording data, for example, an optical disk, a magneto-optical disk, a semiconductor flash memory, or the like.

Each example embodiment of the present invention may be achieved, for example, by configuring a wireless communication device by the information processing device 90 illustrated in FIG. 8 and supplying a program capable of achieving the functions described in each example embodiment to the wireless communication device.

In this case, the example embodiment can be achieved by having the arithmetic device 93 execute the program supplied to the wireless communication device. In addition, not all but some of the functions of the wireless communication device can be configured by the information processing device 90.

Furthermore, the program may be recorded in the recording medium 97, and the program may be stored in the nonvolatile storage device 95 as appropriate at a shipment stage, an operation stage, or the like of the wireless communication device. Note that, in this case, the program supplying method may adopt a method of installing the program in the wireless communication device using an appropriate jig in a manufacturing stage before shipment, an operation stage, or the like. In addition, as a method of supplying the program, a general procedure such as a method of downloading the program from the outside via a communication line such as the Internet may be adopted.

Some or all of the above example embodiments may be described as the following supplementary notes, but are not limited to the following.

### (Supplementary Note 1)

A wireless communication device comprising:
generation means for generating a wireless communication frame;
transmission means for transmitting the wireless communication frame via a first wireless link or a second wireless link; and
measurement means for measuring a first communication quality that is a communication quality of the first wireless link and a second communication quality that is a communication quality of the second wireless link, wherein
the first wireless link is a wireless link used for transmission of the wireless communication frame and the second wireless link is a wireless link having a possibility of being used for transmission of the wireless communication frame,
the generation means changes a size of the wireless communication frame based on the first communication quality and the second communication quality, and generates the wireless communication frame having the changed size, and
the transmission means switches a wireless link used for transmission of the wireless communication frame from the first wireless link to the second wireless link between completion of the transmission of the wireless communication frame and start of transmission of the next wireless communication frame based on the first communication quality and the second communication quality.

### (Supplementary Note 2)

The wireless communication device according to supplementary note 1, wherein
the generation means changes the size of the wireless communication frame by changing number of data frames to be stored in one wireless communication frame.

### (Supplementary Note 3)

The wireless communication device according to supplementary note 1 or 2, wherein
the generation means increases the size in a case where the first communication quality is better than a predetermined threshold and there is no deterioration tendency.

### (Supplementary Note 4)

The wireless communication device according to any one of supplementary notes 1 to 3, wherein
the generation means reduces the size in a case where the first communication quality has deterioration tendency and the second communication quality has improvement tendency.

### (Supplementary Note 5)

The wireless communication device according to any one of supplementary notes 1 to 4, wherein
the generation means reduces the size in a case where a difference between the first communication quality and the second communication quality is smaller than a predetermined range.

### (Supplementary Note 6)

A wireless communication method comprising:
transmitting a wireless communication frame via a first wireless link or a second wireless link;
measuring a first communication quality that is a communication quality of the first wireless link and a second communication quality that is a communication quality of the second wireless link,
wherein the first wireless link is a wireless link used for transmission of the wireless communication frame and the second wireless link is a wireless link having a possibility of being used for transmission of the wireless communication frame;
changing a size of the wireless communication frame based on the first communication quality and the second communication quality, and generating the wireless communication frame having the changed size; and
switching a wireless link used for transmission of the wireless communication frame from the first wireless link to the second wireless link between completion of the transmission of the wireless communication frame and start of transmission of the next wireless communication frame based on the first communication quality and the second communication quality.

### (Supplementary Note 7)

The wireless communication method according to supplementary note 6, wherein
the changing the size of the wireless communication frame is performed by changing number of data frames to be stored in one wireless communication frame.

### (Supplementary Note 8)

The wireless communication method according to supplementary note 6 or 7, wherein
the size is increased in a case where the first communication quality is better than a predetermined threshold and there is no deterioration tendency.

### (Supplementary Note 9)

The wireless communication method according to any one of supplementary notes 6 to 8, wherein
the size is reduced in a case where the first communication quality has deterioration tendency and the second communication quality has improvement tendency.

### (Supplementary Note 10)

The wireless communication method according to any one of supplementary notes 6 to 9, wherein
the size is reduced in a case where a difference between the first communication quality and the second communication quality is smaller than a predetermined range.

### (Supplementary Note 11)

A computer-readable recording medium recorded with a wireless communication program for causing a computer to achieve:
a generation function for generating a wireless communication frame;
a transmission function for transmitting the wireless communication frame via a first wireless link or a second wireless link; and
a measurement function for measuring a first communication quality that is a communication quality of the first wireless link and a second communication quality that is a communication quality of the second wireless link, wherein
the first wireless link is a wireless link used for transmission of the wireless communication frame and the second wireless link is a wireless link having a possibility of being used for transmission of the wireless communication frame,
the generation function changes a size of the wireless communication frame based on the first communication quality and the second communication quality, and generates the wireless communication frame having the changed size, and
the transmission function switches a wireless link used for transmission of the wireless communication frame from the first wireless link to the second wireless link between completion of the transmission of the wireless communication frame and start of transmission of the next wireless communication frame based on the first communication quality and the second communication quality.

### (Supplementary Note 12)

The computer-readable recording medium recorded with the wireless communication program according to supplementary note 11, wherein
the generation function changes the size of the wireless communication frame by changing number of data frames to be stored in one wireless communication frame.

### (Supplementary Note 13)

The computer-readable recording medium recorded with the wireless communication program according to supplementary note 11 or 12, wherein
the generation function increases the size in a case where the first communication quality is better than a predetermined threshold and there is no deterioration tendency.

### (Supplementary Note 14)

The computer-readable recording medium recorded with the wireless communication program according to any one of supplementary notes 11 to 13, wherein
the generation function reduces the size in a case where the first communication quality has deterioration tendency and the second communication quality has improvement tendency.

### (Supplementary Note 15)

The computer-readable recording medium recorded with the wireless communication program according to any one of supplementary notes 11 to 14, wherein
the generation function reduces the size in a case where a difference between the first communication quality and the second communication quality is smaller than a predetermined range.

Although the present invention has been described with reference to the example embodiments, the present invention is not limited to these example embodiments. Various changes that can be understood by those skilled in the art can be made to the configuration and details of the present invention within the scope of the present invention.

This application is based upon and claims the benefit of priority from Japanese Patent Application No. 2021-187500, filed on Nov. 18, 2021, the disclosure of which is incorporated herein in its entirety by reference.

### REFERENCE SIGNS LIST

10, 20 wireless communication device
11, 21 generation unit
12, 22 transmission unit
13, 23 measurement unit
24 first communication unit
25 second communication unit
26 setting unit
27 transmission buffer
50A, 50B, 50C wireless master device
60 information collecting device
90 information processing device
91 communication interface
92 input/output interface
93 arithmetic device
94 storage device
95 non-volatile storage device
96 drive device
97 recording medium

What is claimed is:

1. A wireless communication device comprising one or more memories storing instructions and one or more processors configured to execute the instructions to:
generate a wireless communication frame;
transmit the wireless communication frame via a first wireless link or a second wireless link; and
measure a first communication quality that is a communication quality of the first wireless link and a second communication quality that is a communication quality of the second wireless link, wherein
the first wireless link is a wireless link used for transmission of the wireless communication frame and the second wireless link is a wireless link having a possibility of being used for transmission of the wireless communication frame,
the generation means changes a size of the wireless communication frame based on the first communication quality and the second communication quality, and generates the wireless communication frame having the changed size, and
the transmission means switches a wireless link used for transmission of the wireless communication frame from the first wireless link to the second wireless link between completion of the transmission of the wireless communication frame and start of transmission of the next wireless communication frame based on the first communication quality and the second communication quality.

2. The wireless communication device according to claim 1, wherein
the changing the size of the wireless communication frame is performed by changing number of data frames to be stored in one wireless communication frame.

3. The wireless communication device according to claim 1, wherein
the size is increased in a case where the first communication quality is better than a predetermined threshold and there is no deterioration tendency.

4. The wireless communication device according to claim 1, wherein
the size is reduced in a case where the first communication quality has deterioration tendency and the second communication quality has improvement tendency.

5. The wireless communication device according to claim 1, wherein
the size is reduced in a case where a difference between the first communication quality and the second communication quality is smaller than a predetermined range.

6. A wireless communication method comprising:
transmitting a wireless communication frame via a first wireless link or a second wireless link;
measuring a first communication quality that is a communication quality of the first wireless link and a second communication quality that is a communication quality of the second wireless link,
wherein the first wireless link is a wireless link used for transmission of the wireless communication frame and the second wireless link is a wireless link having a possibility of being used for transmission of the wireless communication frame;
changing a size of the wireless communication frame based on the first communication quality and the second communication quality, and generating the wireless communication frame having the changed size; and
switching a wireless link used for transmission of the wireless communication frame from the first wireless link to the second wireless link between completion of the transmission of the wireless communication frame and start of transmission of the next wireless communication frame based on the first communication quality and the second communication quality.

7. The wireless communication method according to claim 6, wherein
the changing the size of the wireless communication frame is performed by changing number of data frames to be stored in one wireless communication frame.

8. The wireless communication method according to claim 6, wherein
the size is increased in a case where the first communication quality is better than a predetermined threshold and there is no deterioration tendency.

9. The wireless communication method according to claim 6, wherein
the size is reduced in a case where the first communication quality has deterioration tendency and the second communication quality has improvement tendency.

10. The wireless communication method according to claim 6, wherein
the size is reduced in a case where a difference between the first communication quality and the second communication quality is smaller than a predetermined range.

11. A non-transitory computer-readable recording medium recorded with a wireless communication program for causing a computer to achieve:
a generation function for generating a wireless communication frame;
a transmission function for transmitting the wireless communication frame via a first wireless link or a second wireless link; and
a measurement function for measuring a first communication quality that is a communication quality of the first wireless link and a second communication quality that is a communication quality of the second wireless link, wherein
the first wireless link is a wireless link used for transmission of the wireless communication frame and the second wireless link is a wireless link having a possibility of being used for transmission of the wireless communication frame,
the generation function changes a size of the wireless communication frame based on the first communication quality and the second communication quality, and generates the wireless communication frame having the changed size, and
the transmission function switches a wireless link used for transmission of the wireless communication frame from the first wireless link to the second wireless link between completion of the transmission of the wireless communication frame and start of transmission of the next wireless communication frame based on the first communication quality and the second communication quality.

12. The non-transitory computer-readable recording medium recorded with the wireless communication program according to claim 11, wherein
the generation function changes the size of the wireless communication frame by changing number of data frames to be stored in one wireless communication frame.

13. The non-transitory computer-readable recording medium recorded with the wireless communication program according to claim 11, wherein
the generation function increases the size in a case where the first communication quality is better than a predetermined threshold and there is no deterioration tendency.

14. The non-transitory computer-readable recording medium recorded with the wireless communication program according to claim 11, wherein
the generation function reduces the size in a case where the first communication quality has deterioration tendency and the second communication quality has improvement tendency.

15. The non-transitory computer-readable recording medium recorded with the wireless communication program according to claim 11, wherein
the generation function reduces the size in a case where a difference between the first communication quality and the second communication quality is smaller than a predetermined range.
